(19) United States
(12) Patent Application Publication
(10) Pub. No.: US 2009/0159394 A1
(43) Pub. Date: Jun. 25, 2009

(54) COIN-OPERATED LOCKING DEVICE

(75) Inventor: Francisco LU, Kaohsiung (TW)

Correspondence Address: MCNEES WALLACE & NURICK LLC, 100 PINE STREET, P.O. BOX 1166, HARRISBURG, PA, 17108-1166, US

(73) Assignee: MIZ ENGINEERING LTD., Kaohsiung (TW)

(21) Appl. No.: 12/112,578

(22) Filed: Apr. 30, 2008

(30) Foreign Application Priority Data
Dec. 24, 2007 (TW) 096149710

(51) Int. Cl. G07F 5/10; E05B 35/00

(52) U.S. Cl. 194/247; 70/336

(57) ABSTRACT

A coin-operated locking device includes a locking unit, a retaining unit, a driving unit, a coin-actuated unit, a user input unit, and an actuating unit. The locking unit is movable between locking and unlocking positions. The retaining unit is movable between a retaining position, where the retaining unit prevents movement of the locking unit between the locking and unlocking positions, and a non-retaining position, where the retaining unit permits movement of the locking unit between the locking and unlocking positions. The driving unit drives movement of the retaining unit between the retaining and non-retaining positions when actuated. The actuating unit actuates the driving unit upon receipt of the coin-deposited signal from the coin-actuated unit and a user input signal from the user input unit.

### CROSS-REFERENCE TO RELATED APPLICATION

This application claims priority of Taiwanese application no. 096149710, filed on Dec. 24, 2007.

### BACKGROUND OF THE INVENTION

1. Field of the Invention

This invention relates to a coin-operated locking device, more particularly to an electric coin-operated locking device.

2. Description of the Related Art

FIGS. 1 and 2 illustrate a conventional coin-operated locking device that is operable so as to lock a locker (not shown). The conventional coin-operated locking device includes a locking unit 17 and a key operable member 13. The locking unit 17 is movable between locking and unlocking positions. The key operable member 13 is coupled to the locking unit 17, and is operable, such as with the use of a key (not shown), so as to drive movement of the locking unit 17 between the locking and unlocking positions.

In operation, initially, the conventional coin-operated locking device is unlocked. That is, the locking unit 17 is disposed at the unlocking position. When it is desired to lock the conventional coin-operated locking device, a coin is first deposited through a coin insertion hole 11 in the conventional coin-operated locking device. The key operable member 13 is then operated to dispose the locking unit 17 at the locking position.

The conventional coin-operated locking device is disadvantageous in that users must exercise great care so as not to lose the key.

### SUMMARY OF THE INVENTION

Therefore, the object of the present invention is to provide a coin-operated locking device that can overcome the aforesaid drawback of the prior art.

According to the present invention, a coin-operated locking device comprises a support frame, a locking unit, a retaining unit, a driving unit, a coin-actuated unit, a user input unit, and an actuating unit. The locking unit is mounted movably on the support frame, and is movable relative to the support frame between locking and unlocking positions. The retaining unit is mounted movably on the support frame and retains releasably the locking unit at the locking and unlocking positions. The retaining unit is movable relative to the support frame between a retaining position, where the retaining unit prevents movement of the locking unit between the locking and unlocking positions, and a non-retaining position, where the retaining unit permits movement of the locking unit between the locking and unlocking positions. The driving unit is mounted on the support frame, and drives movement of the retaining unit between the retaining and non-retaining positions when actuated. The coin-actuated unit is mounted on the support frame, and generates a coin-deposited signal when actuated. The user input unit is mounted on the support frame and is operable so as to generate a user input signal. The actuating unit is mounted on the support frame, and is coupled electrically to the driving unit, the coin-actuated unit, and the user input unit. The actuating unit actuates the driving unit upon receipt of the coin-deposited signal from the coin-actuated unit and the user input signal from the user input unit.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view to illustrate a coin insertion hole and a key operable member of a conventional coin-operated locking device;

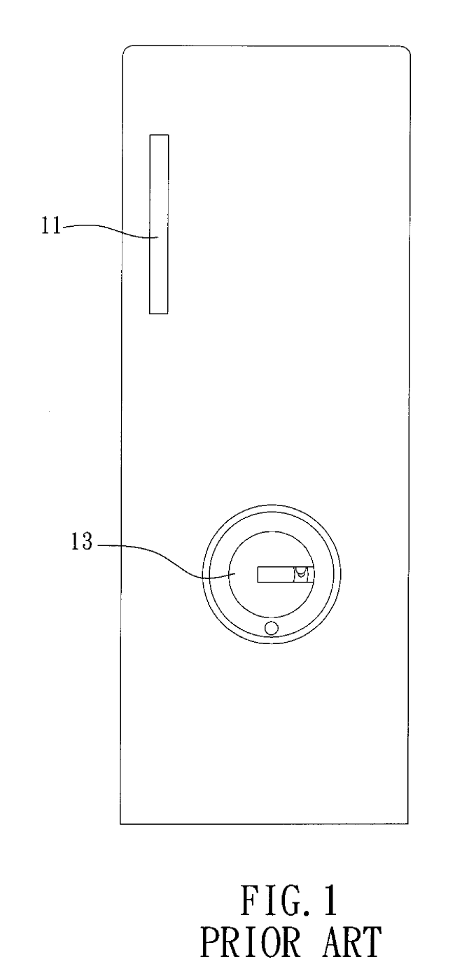

FIG. 2 is a perspective view to illustrate a locking unit of the conventional coin-operated locking device;

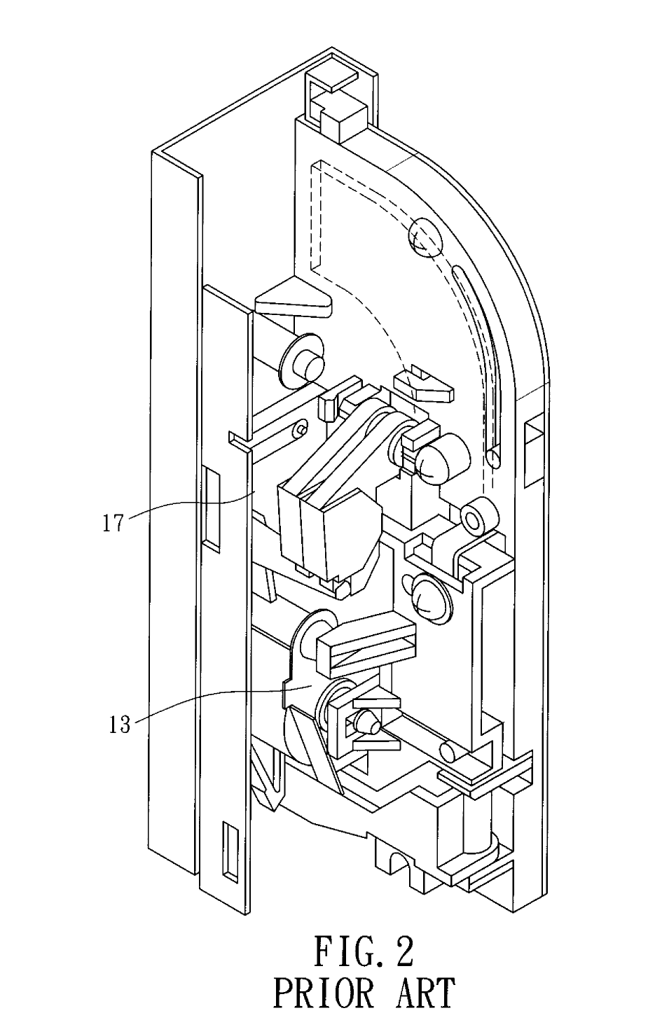

FIG. 3 is a perspective view to illustrate a key insertion hole, a user operable member, and a user input unit of the first preferred embodiment of a coin-operated locking device according to this invention;

FIG. 4 is an exploded perspective view to illustrate a locking unit, a retaining unit, a driving unit, and an actuating unit of the first preferred embodiment;

FIG. 5 is a perspective view of the first preferred embodiment to illustrate a state where the locking unit is disposed at an unlocking position and the retaining unit is disposed at a retaining position;

FIG. 6 is a perspective view of the first preferred embodiment to illustrate a state where the user operable member is operated to dispose the locking unit at a locking position;

FIG. 7 is a perspective view to illustrate a pair of first position-detecting members and a pair of second position-detecting members of the first preferred embodiment;

FIG. 8 is a schematic view of the first preferred embodiment to illustrate a state where one of the second position-detecting members actuates one of the first position-detecting members;

FIG. 9 is a schematic view of the first preferred embodiment to illustrate a state where the other of the second position-detecting members actuates the other of the first position-detecting members;

FIG. 10 is a schematic view to illustrate a coin-depositing unit of the first preferred embodiment;

FIG. 11 is a perspective view of the first preferred embodiment to illustrate a state where a coin is deposited through the coin insertion hole;

FIG. 12 is a perspective view of the first preferred embodiment to illustrate a state where the retaining unit is disposed at a non-retaining position;

FIG. 13 is a perspective view of the first preferred embodiment to illustrate a state where the locking unit is disposed at the locking position and the retaining unit is disposed at the retaining position;

FIG. 14 is a perspective view to illustrate a user operable member of the second preferred embodiment of a coin-operated locking device according to this invention;

FIG. 15 is a perspective view to illustrate an interconnecting member of the second preferred embodiment;

FIG. 16 is a perspective view of the second preferred embodiment to illustrate operation of the user operable member; and

FIG. 17 is a perspective view of the second preferred embodiment to illustrate a state where the locking unit is disposed at the unlocking position and the retaining unit is disposed at the retaining position.

### DETAILED DESCRIPTION OF THE PREFERRED EMBODIMENTS

Before the present invention is described in greater detail, it should be noted that like elements are denoted by the same reference numerals throughout the disclosure.

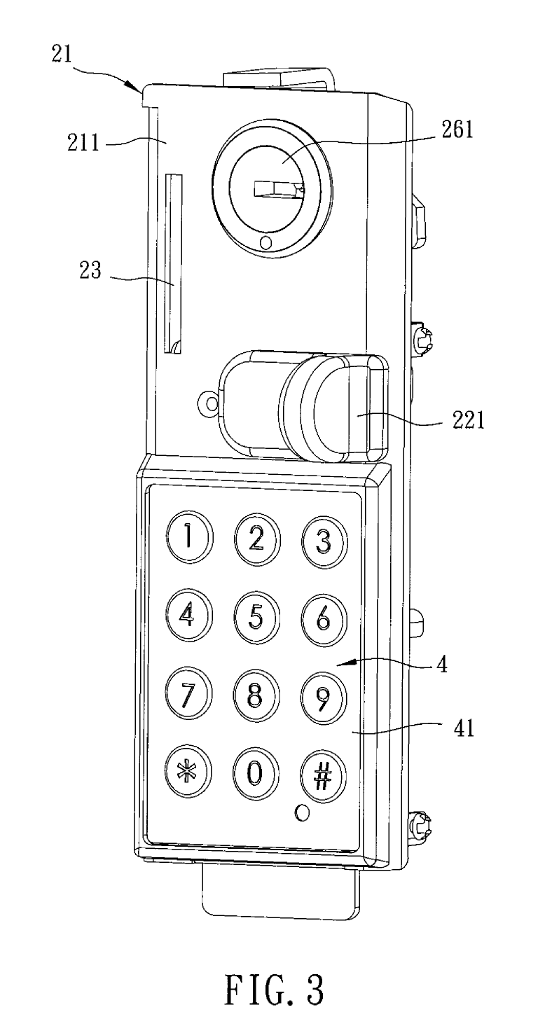

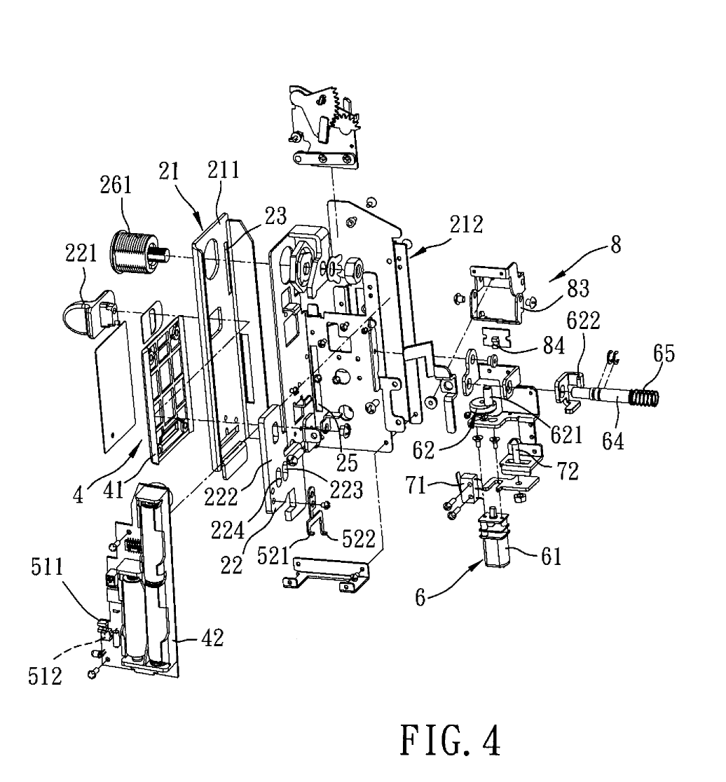

Referring to FIGS. 3 to 5, the first preferred embodiment of a coin-operated locking device according to this invention is shown to include a support frame 21, a locking unit 22, a retaining unit 64, a driving unit 6, a coin-actuated unit 8, a user input unit 4, and an actuating unit 42.

The coin-operated locking device of this invention is operable so as to lock a locker (not shown), in a manner that will be described hereinafter.

The support frame 21 includes front and lateral frame parts 211, 212, each of which is formed with a coin-insertion hole 23, 24 therethrough. In this embodiment, the lateral frame part 212 is further formed with a locking hole 25 therethrough.

The locking unit 22 includes a deadbolt 222 that is mounted movably on the front frame part 211 of the support frame 21 and is formed with first and second retaining holes 224, 223. In this embodiment, the deadbolt 222 of the locking unit 22 is movable relative to the support frame 21 between a locking position, where the deadbolt 222 extends through the locking hole 25 in the lateral frame part 212 of the support frame 21, and an unlocking position, where the deadbolt 222 is retracted so as to be removed from the locking hole 25 in the lateral frame part 212 of the support frame 21.

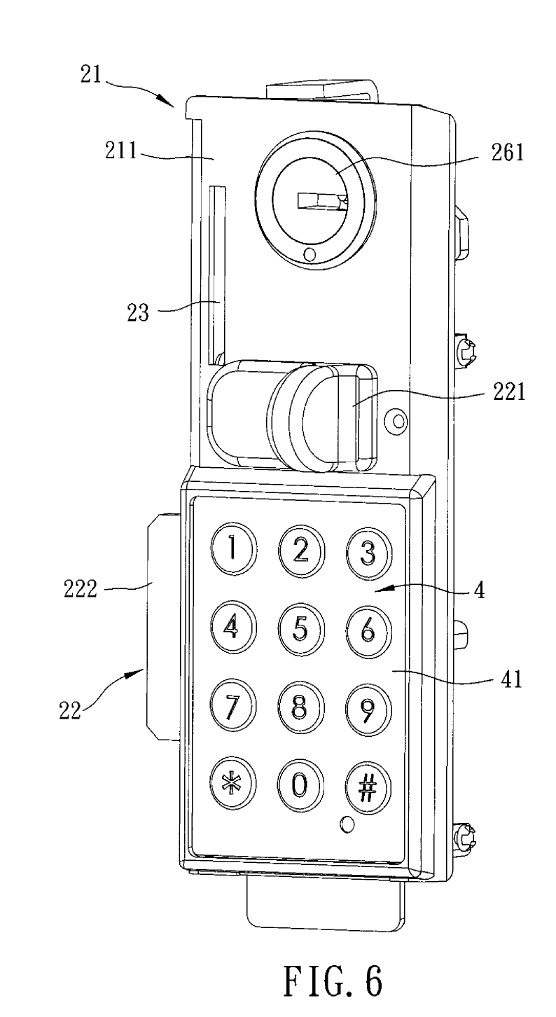

The coin-operated locking device further includes a user operable member 221 that extends movably through the front frame part 211 of the support frame 21 and that is coupled to the deadbolt 222 of the locking unit 22 so as to be co-movable therewith between the locking position, as best shown in FIG. 6, and the unlocking position, as best shown in FIG. 3.

The retaining unit 64 is mounted movably on the lateral frame part 212 of the support frame 21 and serves to retain releasably the deadbolt 222 of the locking unit 22 at the locking and unlocking positions. In particular, the retaining unit 64 is movable relative to the support frame 21 between a retaining position, where the retaining unit 64 extends through the first or second retaining hole 224, 223 in the deadbolt 222, thereby preventing movement of the deadbolt 222 of the locking unit 22 between the locking and unlocking positions, and a non-retaining position, where the retaining unit 64 is retracted out from the first or second retaining hole 224, 223 in the deadbolt 222 of the locking unit 22, thereby permitting movement of the deadbolt 222 of the locking unit 22 between the locking and unlocking positions.

The driving unit 6 is mounted on the support frame 21, and drives movement of the retaining unit 64 between the retaining and non-retaining positions when actuated. In this embodiment, the driving unit 6 includes a cam mechanism 62, a driving member 61, and a biasing member 65. The cam mechanism 62 is operable so as to move the retaining unit 64 to the non-retaining position. In particular, the cam mechanism 62 includes a cam 621, and a cam follower 622 coupled to the retaining unit 64 so as to be co-movable therewith between the retaining and non-retaining positions. The driving member 61 of the driving unit 6 is coupled to the cam 621 and is operable so as to drive rotation of the cam 621. The biasing member 65 biases the retaining unit 64 to the retaining position. In particular, the biasing member 65 is sleeved on the retaining unit 64, and has opposite ends that abut respectively against the support frame 21 and the retaining unit 64.

The coin-actuated unit B includes first and second actuated members 84, 83. The first actuated member 84 is mounted on the lateral frame part 212 of the support frame 21, and generates a coin-deposited signal when actuated. The second actuated member 83 is coupled pivotably to the lateral frame part 212 of the support frame 21, and is pivotable relative to the support frame 21 between an actuating position, where the first actuated member 84 does not detect the second actuated member 83, and a non-actuating position, where the first actuated member 84 detects the second actuated member 83. In this embodiment, the second actuated member 83 actuates the first actuated member 84 when the second actuated member 83 is disposed at the actuating position.

The user input unit 4 is mounted on the front frame part 211 of the support frame 21, and includes a keypad 41 that is operable so as to generate a user input signal.

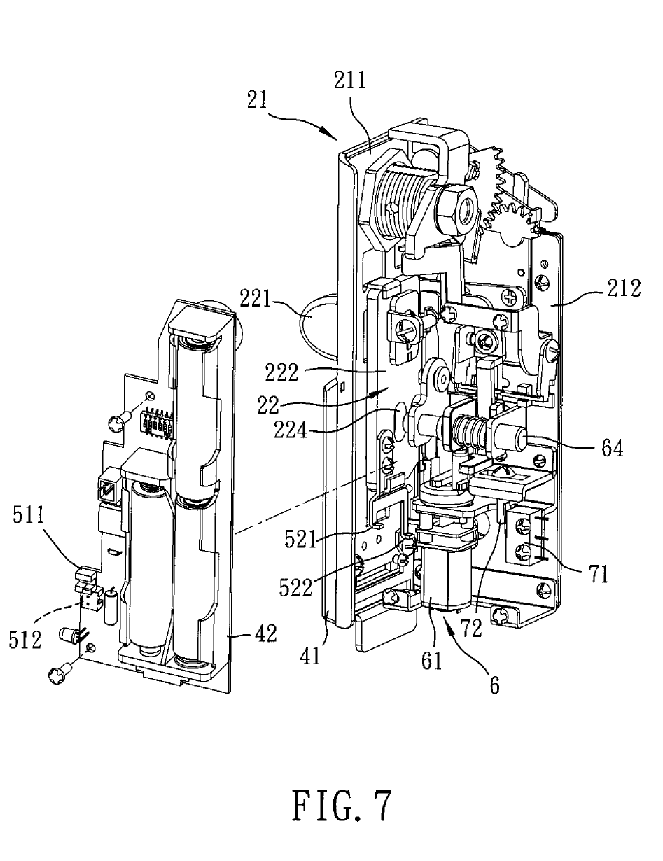

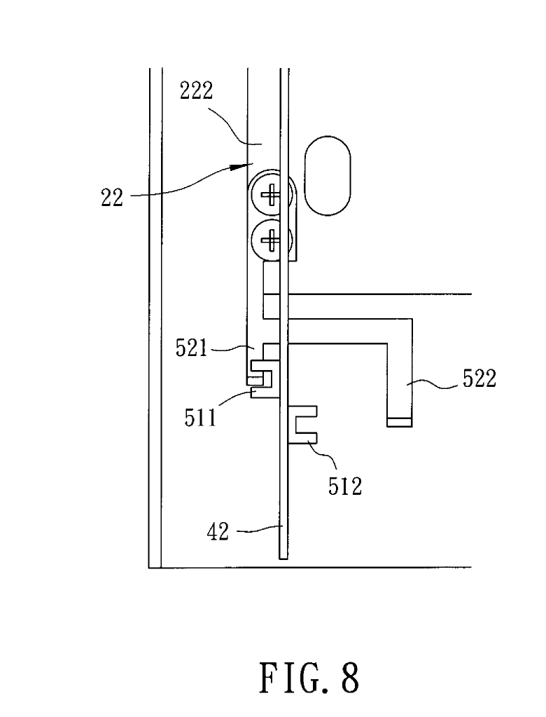

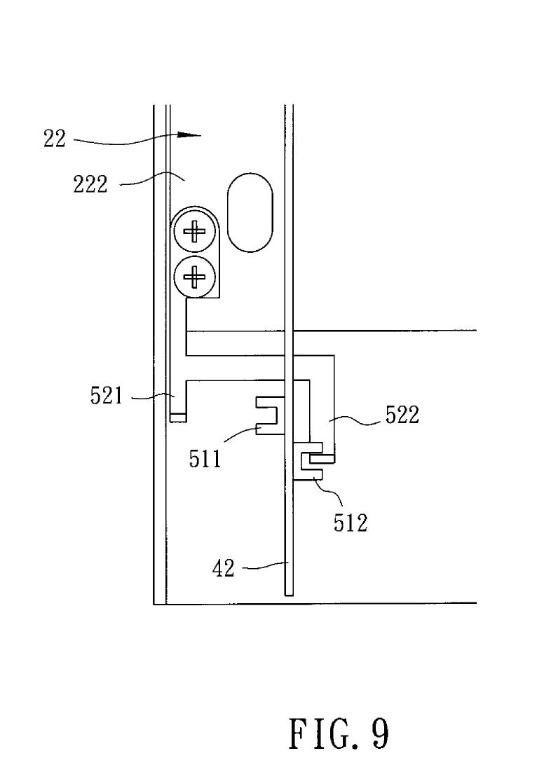

With further reference to FIG. 7, the coin-operated locking device further includes a pair of first position-detecting members 511, 512 and a pair of second position-detecting members 521, 522. Each of the first position-detecting members 511, 512 is mounted on the actuating unit 42, and generates a positioning signal when actuated. Each of the second position-detecting members 521, 522 is coupled to the deadbolt 222 of the locking unit 22 so as to be co-movable therewith between the locking and unlocking positions. As best shown in FIG. 8, when the deadbolt 222 of the locking unit 22 is disposed at the locking position, the first position-detecting member 511 detects the second position-detecting member 521 and the first position-detecting member 512 does not detect the second position-detecting member 522. On the other hand, as best shown in FIG. 9, when the deadbolt 222 of the locking unit 22 is disposed at the unlocking position, the first position-detecting member 512 detects the second position-detecting member 522, and the first position-detecting member 511 does not detect the second position-detecting member 521. In this embodiment, the first position-detecting member 511 is actuated when the second position-detecting member 521 is detected thereby. Moreover, in this embodiment, the first position-detecting member 512 is actuated when the second position-detecting member 522 is detected thereby.

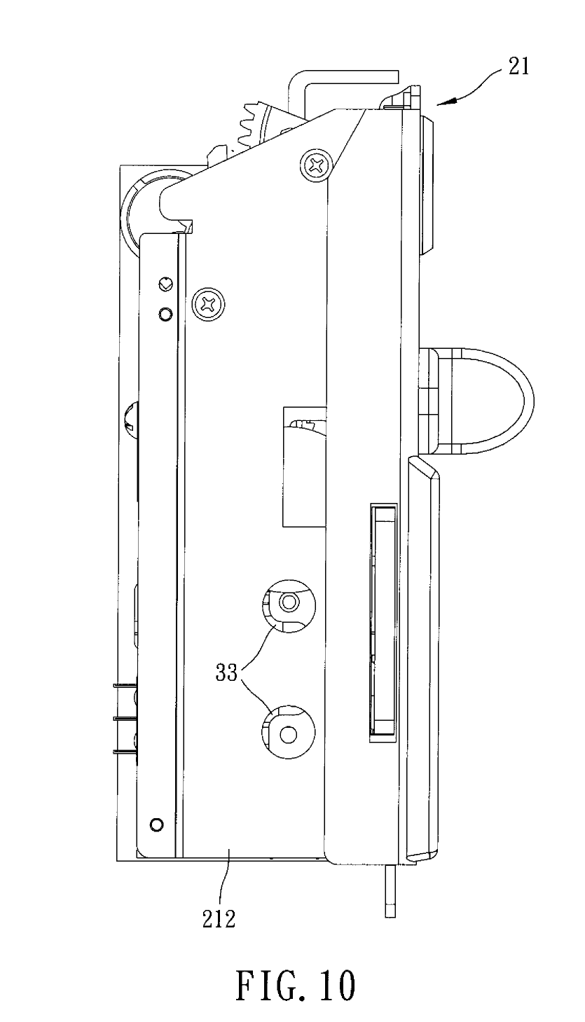

The coin-operated locking device further includes a coin-depositing unit 33 (see FIG. 10) mounted on the lateral frame part 212 of the support frame 21.

The actuating unit 42 is mounted on the front frame part 211 of the support frame 21, and is coupled electrically to the driving member 61 of the driving unit 6, the first actuated member 84 of the coin-actuated unit 8, the keypad 41 of the user input unit 4, the first position-detecting members 511, 512, and the coin-depositing unit 33.

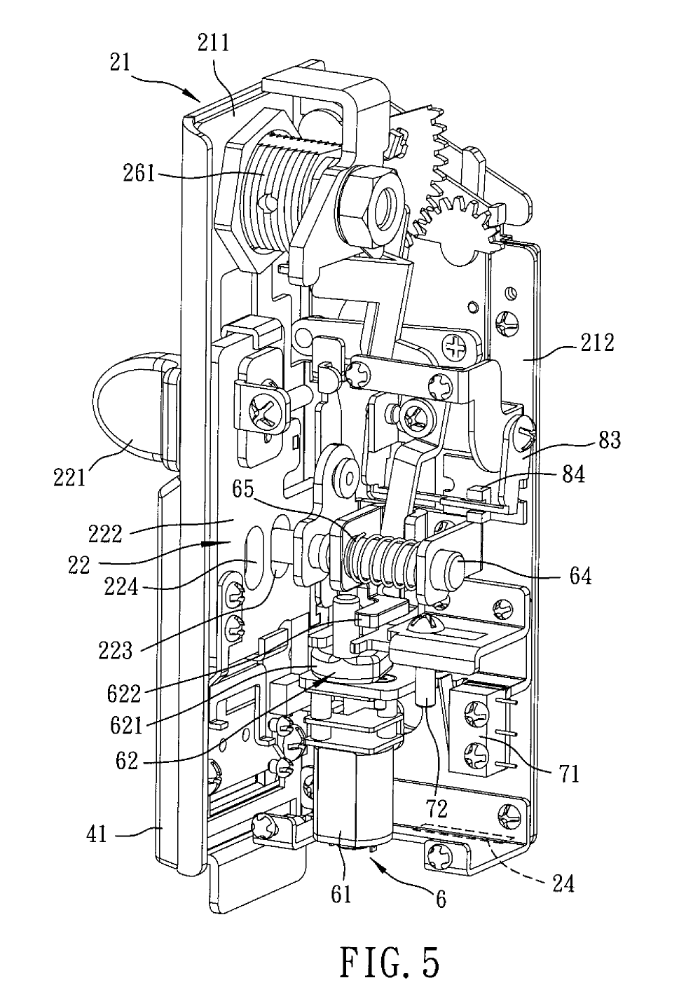

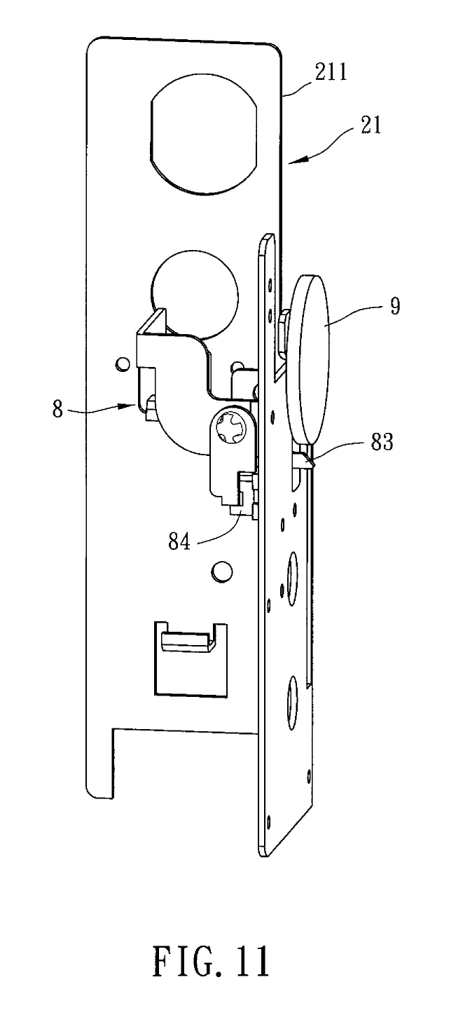

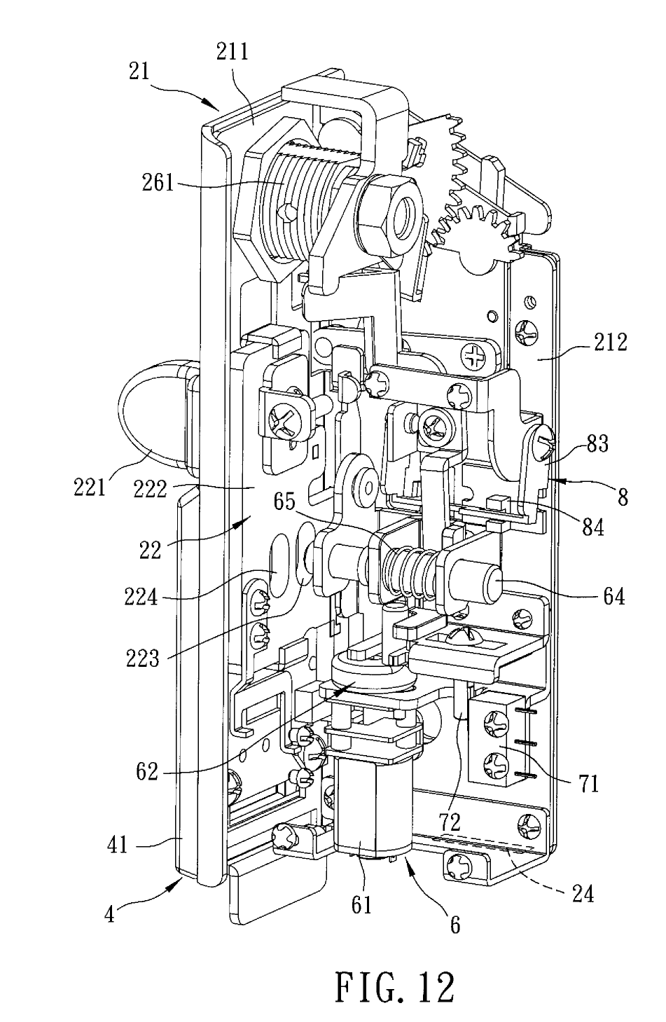

In operation, when the coin-operated locking device of this invention is unlocked, as best shown in FIG. 5, the deadbolt 222 of the locking unit 22 is disposed at the unlocking position, the retaining unit 64 is disposed at the engaging position, i.e., the retaining unit 64 extends through the second retaining hole 223 in the deadbolt 222 of the locking unit 22, and the second actuated member 83 of the coin-actuated unit 8 is disposed at the non-actuating position. When it is desired to lock the coin-operated locking device of this invention, as illustrated in FIG. 11, a coin 9 is first deposited through the coin-insertion hole 23 in the front frame part 211 of the support frame 21. The coin causes movement of the second actuated member 83 of the coin-actuated unit 8 to the actuating position, thereby permitting the second actuated member 83 to actuate the first actuated member 84 to generate the coin-deposited signal, and is retained by the coin-depositing unit 33 thereat. Subsequently, a key, such the number sign (#) key, of the keypad 41 of the user input unit 4 is operated such that the actuating unit 42 actuates the coin-depositing unit 33 to release the coin 9, thereby permitting the coin 9 to drop through the coin-insertion hole 24 in the lateral frame part 212 of the support frame 21. Then, an input, e.g., a password, is entered through the keypad 41 of the user input unit 4, thereby permitting the keypad 41 of the user input unit 4 to generate the user input signal. Thereafter, the actuating unit 42 receives the coin-deposited signal from the first actuated member 84 of the coin-actuated unit 8 and the user input signal from the keypad 41 of the user input unit 4, and actuates the driving member 61 of the driving unit 6, which in turn operates the cam mechanism 62 of the driving unit 6 to move the retaining unit 64 to the non-retaining position against a biasing force of the biasing member 65, i.e., the retaining unit 64 is retracted so as to removed from the second retaining hole 223 in the deadbolt 222 of the locking unit 22, as best shown in FIG. 12. At this time, the deadbolt 222 of the locking unit 22 may be disposed at the locking position via the user operable member 221 to lock the coin-operated locking device of this invention.

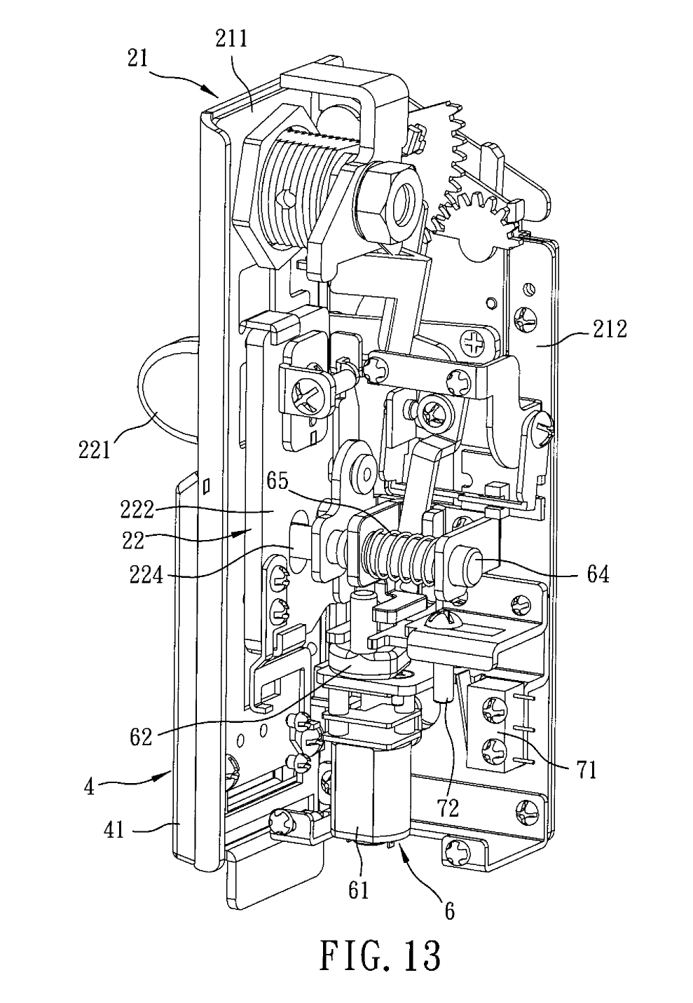

It is noted that when the deadbolt 222 of the locking unit 22 is disposed at the locking position, the second position-detected member 521 actuates the first position-detecting member 511 to generate the positioning signal. Thereafter, the actuating unit 42 receives the positioning signal from the first position-detecting member 511, and actuates the driving member 61 of the driving unit 6, which in turn operates the cam mechanism 62 of the driving unit 6 to permit the biasing member 65 to dispose the retaining unit 64 at the retaining position, i.e., the retaining unit 64 extends through the first retaining hole 224 in the deadbolt 222 of the locking unit 22, as best shown in FIG. 13.

When it is desired to unlock the coin-operated locking device of this invention, the password is first entered through the keypad 41 of the user input unit 4, thereby permitting the keypad 41 of the user input unit 4 to generate the user input signal. Then, the actuating unit 42 receives the user input signal from the keypad 41 of the user input unit 4, and actuates the driving member of the driving unit 6, which in turn operates the cam mechanism 62 of the driving unit 6 to dispose the retaining unit 64 at the non-retaining position against the biasing force of the biasing member 65, i.e., the retaining unit 64 is retracted so as to be removed from the first retaining hole 224 in the deadbolt 222 of the locking unit 22, as best shown in FIG. 12. At this time, the deadbolt 222 of the locking unit 22 may be disposed at the unlocking position via the user operable member 221 to unlock the coin-operated locking device of this invention.

It is noted that when the deadbolt 222 of the locking unit 22 is disposed at the unlocking position, the second position-detected member 522 actuates the first position-detecting member 512 to generate the positioning signal. Thereafter, the actuating unit 42 receives the positioning signal from the first position-detecting member 512, and, after a time period has elapsed since the receipt of the positioning signal thereby, actuates the driving member 61 of the driving unit 6, which in turn operates the cam mechanism 62 of the driving unit 6 to permit the biasing member 65 to dispose the retaining unit 64 at the retaining position, i.e., the retaining unit 64 extends through the second retaining hole 223 in the deadbolt 222 of the locking unit 22, as best shown in FIG. 5.

The coin-operated locking device further includes a key operable member 261 that extends through the front frame part 211 of the support frame 21, that is coupled to the cam follower 622 of the cam mechanism 62 of the driving unit 6, and that is operable, such as with the use of a key (not shown), so as to drive movement of the cam follower 622. As such, when the user forgets the password, the key operable member 261 may be operated, such as by an authorized personnel, to dispose the retaining unit 64 at the non-retaining position.

In this embodiment, the actuating unit 42 deactivates the driving member 61 of the driving unit 6 when the retaining unit 64 is disposed at the non-retaining position. In particular, the coin-operated locking device further includes first and second deactivating members 71, 72. The first deactivating member 71 is mounted on the lateral frame part 212 of the support frame 21, and generates a deactivating signal when actuated. The second deactivating member 72 is mounted movably on the support frame 21. In this embodiment, the second deactivating member 72 is movable relative to the support frame 21 to a deactivating position, where the second deactivating member 72 actuates the first deactivating member 71. The cam mechanism 62 is further operable so as to move the second deactivating member 72 to the deactivating position at the same time when the retaining unit 64 is moved thereby to the non-retaining position. The actuating unit 42 is further coupled electrically to the first deactivating member 71, and deactivates the driving member 61 of the driving unit 6 upon receipt of the deactivating signal from the first deactivating member 71.

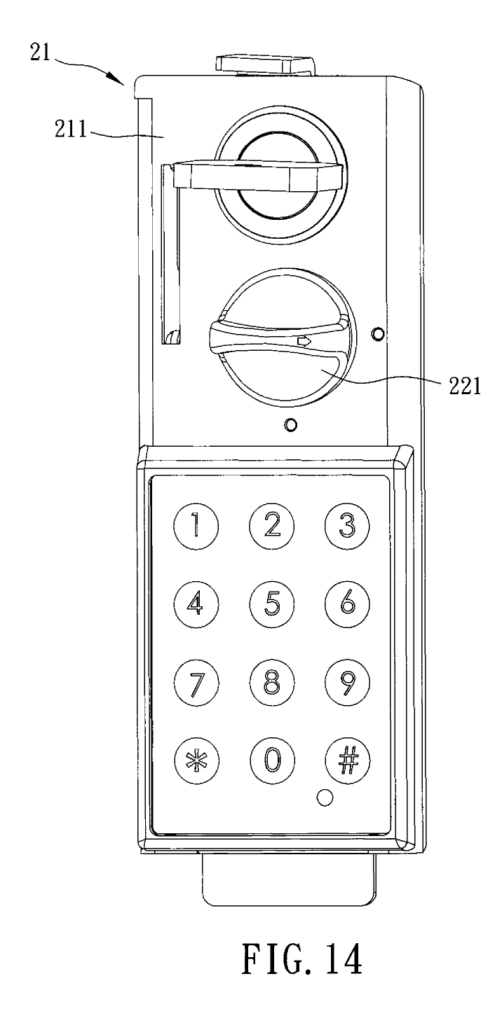

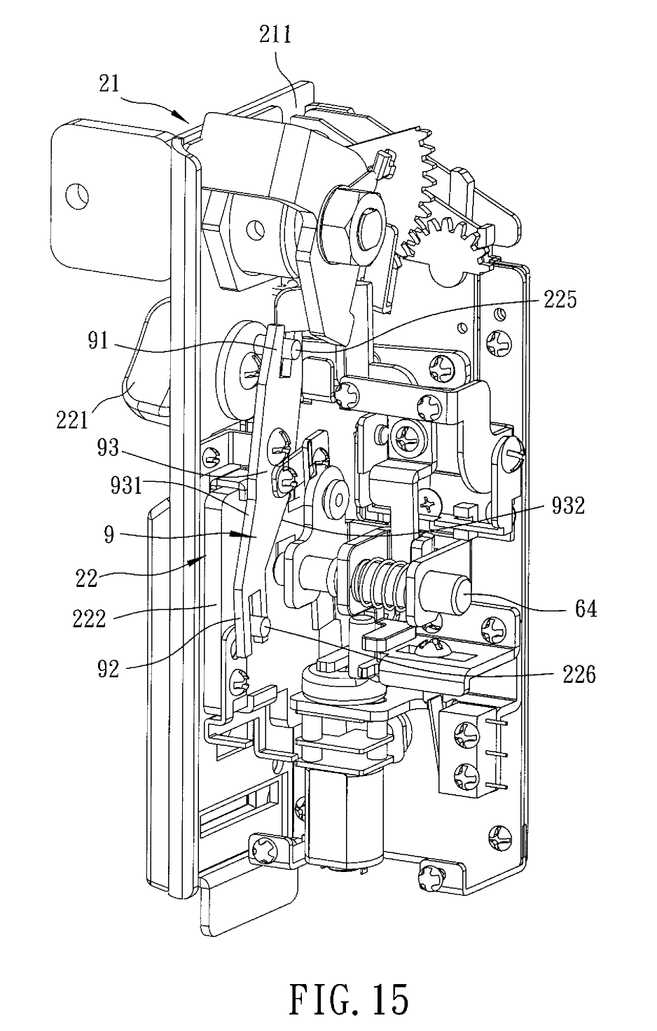

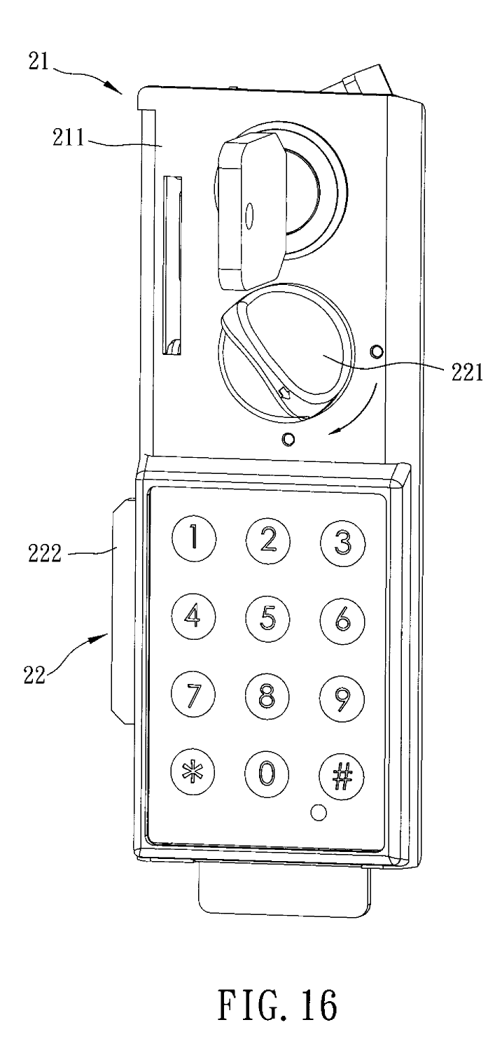

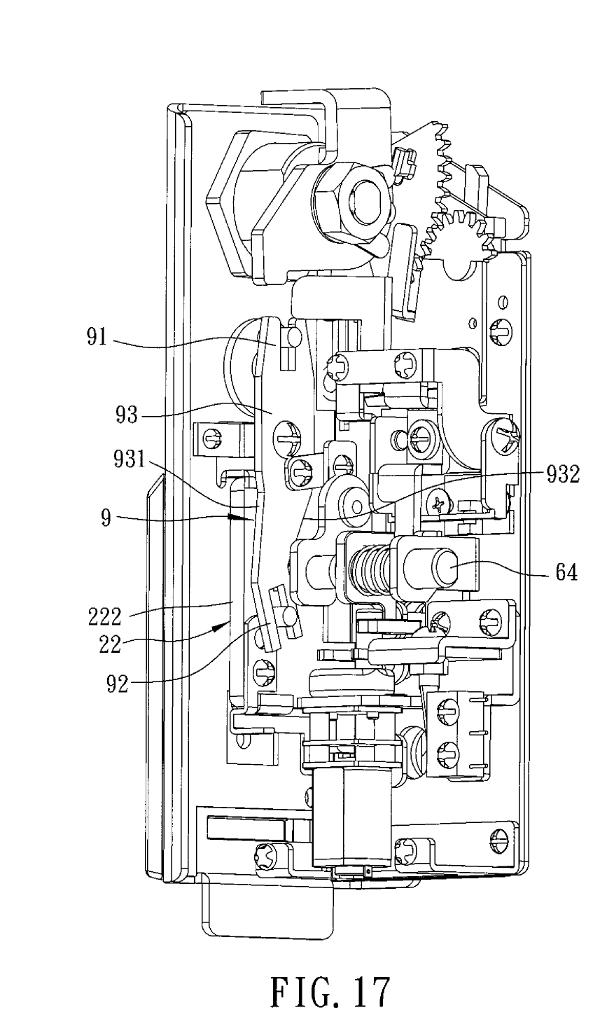

FIGS. 14 and 15 illustrate the second preferred embodiment of a coin-operated locking device according to this invention. When compared to the previous embodiment, the user operable member 221 extends rotatably through the front frame part 211 of the support frame 21 and is formed with a protrusion 225. The deadbolt 222 of the locking unit 22 is formed with a protrusion 226. The coin-operated locking device of this embodiment further includes an interconnecting member 9. The interconnecting member 9 has opposite first and second ends 91, 92, each of which is sleeved on a respective one of the protrusion 225 of the user operable member 221 and the protrusion 226 of the deadbolt 222, and an intermediate portion 93 that is disposed between the first and second ends 91, 92 thereof and that has opposite first and second sides 931, 932. When the retaining unit 64 is disposed at the non-retaining position, the user operable member 221 may be rotated to drive movement of the deadbolt 222 of the locking unit 22 via the interconnecting member 9 between the locking and unlocking positions, as best shown in FIG. 16. Moreover, when the deadbolt 222 of the locking unit 22 is disposed at the unlocking position and when the retaining unit 64 is disposed at the retaining position, the retaining unit 64 abuts against the second side 932 of the intermediate portion 93 of the interconnecting member 9, thereby preventing movement of the deadbolt 222 to the locking position, as best shown in FIG. 17. Further, when the deadbolt 222 of the locking unit 22 is disposed at the locking position and when the retaining unit 64 is disposed at the retaining position, the retaining unit 64 abuts against the first side 931 of the intermediate portion 93 of the interconnecting member 9, thereby preventing movement of the deadbolt 222 to the unlocking position.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A coin-operated locking device, comprising:
a support frame;
a locking unit mounted movably on said support frame, said locking unit being movable relative to said support frame between locking and unlocking positions;
a retaining unit mounted movably on said support frame and retaining releasably said locking unit at the locking and unlocking positions, said retaining unit being movable relative to said support frame between a retaining position, where said retaining unit prevents movement of said locking unit between the locking and unlocking positions, and a non-retaining position, where said retaining unit permits movement of said locking unit between the locking and unlocking positions;
a driving unit mounted on said support frame, and driving movement of said retaining unit between the retaining and non-retaining positions when actuated;
a coin-actuated unit mounted on said support frame, and generating a coin-deposited signal when actuated;
a user input unit mounted on said support frame and operable so as to generate a user input signal; and
an actuating unit mounted on said support frame, and coupled electrically to said driving unit, said coin-actuated unit, and said user input unit,
said actuating unit actuating said driving unit upon receipt of the coin-deposited signal from said coin-actuated unit and the user input signal from said user input unit.

2. The coin-operated locking device as claimed in claim 1, wherein said locking unit includes a deadbolt that is movable relative to the support frame between the locking and unlocking positions, said coin-operated locking device further comprising a user operable member extending movably through said support frame, and coupled to said deadbolt of said locking unit so as to be co-movable therewith between the locking and unlocking positions.

3. The coin-operated locking device as claimed in claim 2, wherein said deadbolt of said locking unit is formed with spaced apart first and second retaining holes therethrough,
said retaining unit extending into said first retaining hole when said deadbolt of said locking unit is disposed at the locking position and when said retaining unit is disposed at the retaining position,
said retaining unit extending into said second retaining hole when said deadbolt of said locking unit is disposed at the unlocking position and when said retaining unit is disposed at the retaining position.

4. The coin-operated locking device as claimed in claim 1, further comprising:
a first position-detecting member mounted on said actuating unit, and generating a positioning signal when actuated; and
a second position-detecting member coupled movably to said locking unit so as to be co-movable therewith between the locking and unlocking positions, and actuating said first position-detecting member when said locking unit is disposed at the locking and unlocking positions,
said actuating unit being further coupled electrically to said first position-detecting member, and actuating said driving unit upon receipt of the positioning signal from said first position-detecting member.

5. The coin-operated locking device as claimed in claim 1, further comprising:
a first deactivating member mounted on said support frame, and generating a deactivating signal when actuated, and
a second deactivating member mounted movably on said support frame, said second deactivating member being movable relative to said support frame to a deactivating position, where said second deactivating member actuates said first deactivating member,
said actuating unit being further coupled electrically to said first deactivating member, and deactivating said driving unit upon receipt of the deactivating signal from said first deactivating member.

6. The coin-operated locking device as claimed in claim 1, wherein said coin-actuated unit includes
a first actuated member that is mounted on said support frame, and that generates the coin-deposited signal when actuated, and
a second actuated member that is mounted movably on said support frame, and said second actuated member being movable relative to said support frame to an actuating position, where said second actuated member actuates said first actuated member.

7. The coin-operated locking device as claimed in claim 1, wherein said driving unit includes
a cam mechanism that is operable so as to move said retaining unit to the non-retaining position,
a driving member that is coupled to said cam mechanism and that drives movement of said cam mechanism, and
a biasing member that biases said retaining unit to the retaining position.

8. The coin-operated locking device as claimed in claim 7, further comprising a key operable member extending through said support frame, coupled to said cam mechanism, and operable so as to drive movement of said cam mechanism.

9. The coin-operated locking device as claimed in claim 1, wherein said locking unit includes a deadbolt that is movable relative to said support frame between the locking and unlocking positions, and that is formed with a protrusion, said coin-operated locking device further comprising:
a user operable member extending rotatably through said support frame and formed with a protrusion; and
an interconnecting member having opposite first and second ends, each of which is sleeved on a respective one of said protrusion of said deadbolt and said protrusion of said user operable member.

10. The coin-operated locking device as claimed in claim 9, wherein said interconnecting member further has an intermediate portion that is disposed between said first and second ends thereof,
said retaining unit abutting against said intermediate portion of said interconnecting member when said deadbolt of said locking unit is disposed at the locking position and when said retaining unit is disposed at the retaining position,
said retaining unit abutting against said intermediate portion of said interconnecting member when said deadbolt of said locking unit is disposed at the unlocking position and when said retaining unit is disposed at the retaining position.
